(19) United States
(12) Patent Application Publication
(10) Pub. No.: US 2016/0110827 A1
(43) Pub. Date: Apr. 21, 2016

(54) Methods and Systems for Exchanging Electronic Documents

(71) Applicant: Electronic Document Exchange Inc., Toronto (CA)

(72) Inventors: Michael Harris Tweyman, Toronto (CA); Arin Lionel Klug, Toronto (CA)

(21) Appl. No.: 14/518,072

(22) Filed: Oct. 20, 2014

(51) Int. Cl. G06Q 50/18; G06Q 10/10

(52) U.S. Cl. CPC G06Q 50/18; G06Q 10/10

(57) ABSTRACT

Methods and systems are provided for exchanging electronic documents. An example method, and system implementing the method, can include receiving an exchange initiation request from an exchange creator, the exchange initiation request including a set of user identifiers; receiving a document submission request from a sender; storing the electronic document in a storage component when the sender is authenticated; receiving, from the sender, a recipient list for the electronic document, the recipient list indicating intended recipients of the electronic document; providing the intended recipients with access to the electronic document; and generating an exchange record for the electronic document, the exchange record providing a receipt confirmation indicating the electronic document was received and a receipt verification link to the exchange record stored in the storage component.

### FIELD

The described embodiments relate to methods and systems for exchanging electronic documents and in particular, for exchanging electronic documents for legal proceedings.

### BACKGROUND

Information exchange is continuously evolving with technological advancements. The widespread availability of various forms of electronic communication, for example, has facilitated information sharing between different entities.

Electronic mail (e-mail), for instance, provides for nearly instantaneous transmission of messages to other(s). The messages can also include various media types, such as documents, images, etc. Electronic exchange systems that can electronically receive information (e.g., documents) from one user and electronically provide that information to other users can minimize restrictions associated with physical submission boxes and/or availability of staff to receive the information. Information exchange, therefore, is now less restricted by transit time and accessibility of physical submission locations.

However, as information exchange increases in convenience, certain aspects of information exchange may require further consideration. In certain settings, for example, the time at which a document is received by an electronic exchange system can be critical. Although there is less restriction on when submissions can be received, the electronic exchange system should nevertheless operate to provide timely responses to the submissions. Continuous authentication of the submission may also be required depending on the impact that the submission may have.

For example, legal proceedings generally involve a rigid timeline for each party to submit documents to each other as well as to respond to the submissions from the other party. The authenticity of the legal documents may, in some cases, be also difficult to verify due, at least, to the large volume of documents generally associated with legal proceedings.

Electronic document exchange systems can facilitate information exchange. Other aspects of the information exchange, such as verification and authentication, may also be enhanced.

### SUMMARY

The various embodiments described herein generally relate to methods (and associated systems configured to implement the methods) for exchanging electronic documents. Generally, the various embodiments described herein may be applied in systems that involve some verification of the submission of the electronic documents. For example, the various embodiments described herein may be directed to the exchange of electronic documents for legal proceedings, for educational purposes, and other similar applications.

In some embodiments, there is provided a method of exchanging electronic documents for a legal proceeding. The method including: receiving, by a document exchange system, an exchange initiation request from an exchange creator, the exchange initiation request comprising a set of user identifiers and the set of user identifiers including two or more user identifiers corresponding to respective users associated with the legal proceeding; receiving, by the document exchange system, a document submission request from a sender for the legal proceeding, the sender being associated with a sender identifier, wherein receiving the document submission request comprises determining whether the sender identifier is within the set of user identifiers to authenticate the sender is a user associated with the legal proceeding and receiving an electronic document from the sender; storing the electronic document in a storage component when the sender is authenticated and otherwise, indicate the sender is not associated with the legal proceeding, the storage component being in electronic communication with the document exchange system; receiving, from the sender, a recipient list for the electronic document, the recipient list comprising one or more recipient identifiers associated with one or more respective intended recipients of the electronic document and the one or more recipient identifiers being within the set of user identifiers; providing the one or more intended recipients with access to the electronic document; and in response to providing the one or more intended recipients with access to the electronic document, generating, by the document exchange system, an exchange record for the electronic document, the exchange record providing, at least, (i) a receipt confirmation indicating the electronic document was received by the document exchange system and (ii) a receipt verification link to the exchange record stored in the storage component.

In some embodiments, the storage component may be separate from the document exchange system.

For example, in some embodiments, the receipt verification link can include a Universal Resource Link (URL) that provides access to the exchange record stored in the storage component.

In some embodiments, the exchange record may include an access link to the electronic document stored in the storage component. The access link can, in some embodiments, include a URL that provides access to the electronic document stored in the storage component. The URL may be encoded as a Quick Response (QR) code in some embodiments.

In some embodiments, generating the exchange record for the electronic document may include generating a unique exchange record for each recipient identifier in the recipient list, each unique exchange record including, at least, a recipient name associated with the respective recipient identifier.

In some embodiments, generating the exchange record for the electronic document may include providing the sender with access to the exchange record.

The exchange record, in some embodiments, can include data associated with at least one of (i) the electronic document and (ii) the legal proceeding. The data associated with the electronic document can include a screenshot of at least one page of the electronic document.

The receipt confirmation can, in some embodiments, include at least a timestamp and a recipient name corresponding to at least one recipient identifier in the recipient list.

In some embodiments, providing the one or more intended recipients with access to the electronic document via the document exchange system may include: generating a notification of the receipt of the electronic document by the document exchange system; and transmitting the notification to the one or more intended recipients.

The two or more user identifiers can, in some embodiments, include a user identifier corresponding to at least one of (i) a party to the legal proceeding and (ii) a legal counsel for one of the parties to the legal proceeding,

The exchange creator can, in some embodiments, include an administrator user who is not associated with a user identifier within the set of user identifiers.

In some embodiments, there is provided a system of exchanging electronic documents for a legal proceeding. The system including: a storage component; and at least one processor in electronic communication with the storage component, the at least one processor being configured to: receive an exchange initiation request from an exchange creator, the exchange initiation request comprising a set of user identifiers and the set of user identifiers including two or more user identifiers corresponding to respective users associated with the legal proceeding; receive an electronic document from a sender for the legal proceeding, the sender being associated with a sender identifier, wherein receiving the electronic document comprises determining whether the sender identifier is within the set of user identifiers to authenticate the sender is a user associated with the legal proceeding; storing the electronic document in the storage component when the sender is authenticated and otherwise, indicate the sender is not associated with the legal proceeding; receive, from the sender, a recipient list for the electronic document, the recipient list comprising one or more recipient identifiers associated with one or more respective intended recipients of the electronic document and the one or more recipient identifiers being within the set of user identifiers; provide the one or more intended recipients with access to the electronic document; and in response to providing the one or more intended recipients with access to the electronic document, generate an exchange record for the electronic document, the exchange record providing, at least, (i) a receipt confirmation indicating the electronic document was received and (ii) a receipt verification link to the exchange record stored in the storage component.

### BRIEF DESCRIPTION OF THE DRAWINGS

Several embodiments will now be described in detail with reference to the drawings, in which:

FIG. 1 is a block diagram of components interacting with a document exchange system in accordance with an example embodiment;

FIG. 2 is a flowchart of an example embodiment of various methods of exchanging electronic documents;

FIG. 3 is a screenshot of a user profile within the document exchange system in accordance with an example embodiment;

FIGS. 4A and 4B are screenshots of a new user invitation interface within the document exchange system in accordance with an example embodiment;

FIGS. 5A and 5B are screenshots of an exchange initiation request interface in accordance with an example embodiment;

FIG. 5C is a screenshot of an exchange summary interface in accordance with an example embodiment;

FIG. 6A is a screenshot of a document upload interface in accordance with an example embodiment;

FIG. 6B is a screenshot of a recipient selection interface in accordance with an example embodiment;

FIG. 6C is a screenshot of the exchange summary interface of FIG. 5C at a different time in accordance with an example embodiment;

FIG. 6D is a screenshot of another exchange summary interface in accordance with another example embodiment; and

FIG. 7 is a screenshot of an exchange record in accordance with an example embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to methods (and associated systems configured to implement the methods) for exchanging electronic documents. Generally, the various embodiments described herein may be applied in systems that involve a degree of verification of the submission of the electronic documents. For example, the various embodiments described herein may be directed to the exchange of electronic documents for legal proceedings, for educational purposes, and other similar applications.

Generally, the methods described herein can include receiving an exchange initiation request from an exchange creator. The exchange creator may be an administrative user who is not part of the document exchange or may be a user associated with the document exchange. For example, when the methods are used for the exchange of electronic documents for legal proceedings, the exchange creator may include a user associated with the legal proceeding itself, such as a party to the legal proceeding or a legal counsel for a party to the legal proceeding. The exchange initiation request can include a set of user identifiers that identify the users who are associated with the legal proceeding, for example, and will participate, to some extent, to the exchange of documents—whether as senders of the documents, recipients of the documents and/or viewers of the documents.

After the exchange initiation request is received by the document exchange system, a document submission request can be received from a sender. The sender can be associated with a user identifier, or referred to as a sender identifier. When the document submission request is received by the document exchange system, the document exchange system can authenticate the sender to ensure that the sender is authorized to engage in the document exchange and to receive an electronic document from the sender. For example, the document exchange system can authenticate the sender by determining whether the sender identifier is within the set of user identifiers provided by the exchange creator, When the document exchange system determines that the sender is authorized to engage in that particular document exchange, the document exchange system can store the received electronic document in a storage component The described system can also receive a recipient list for the electronic document from the sender. The recipient list can identify the users from the set of user identifiers who are intended to be provided with access to the electronic document and/or a listing of electronic documents for which each of the users can access via the document exchange system.

When the intended recipients are provided with access to the electronic document, the described systems can then generate an exchange record. The exchange record can include various different information. In particular, the exchange record can include a confirmation of receipt of the electronic document (or receipt confirmation data) and a receipt verification link to the exchange record stored in the storage component. Other information, such as the sender identifier and certain properties of the electronic document, may similarly be provided by the exchange record.

The exchange record can be applied in electronic document exchange systems that involve certain time limits on document submissions by any of the associated users. As electronic document exchange systems become more prevalently used, the ability to efficiently regulate and verify the submissions increases in importance. In legal proceedings, for example, certain documents must be served on the other party within a regulated time period. The exchange record can therefore be proof of when the document was submitted by the sender. However, it can be difficult to verify which version of the electronic document led to the generation of the exchange record.

An example verification of the electronic document may involve providing the receipt verification link. When an exchange record is provided as proof of a submission, the individual responsible for verifying the submission can access the stored exchange record via the receipt verification link and verify the exchange record by comparing the exchange record with the stored exchange record.

Another example verification of the electronic document may involve providing an access link as part of the exchange record. By providing the access link as part of the exchange record, the version of the electronic document can, in some embodiments, be easily verified by an individual with access to the exchange record. As briefly noted, in certain legal proceedings, strict timelines may be set for each of the parties to serve onto the other party certain documents. This helps to ensure fairness in the legal proceedings so that the recipient of the document will have sufficient time to respond and for the legal proceeding itself to be as expedient as possible. Therefore, while the ability to show that documents were submitted and made available by the relevant parties by a certain time can be crucial, it may, in some cases, be important to facilitate access to the document associated with the exchange record.

With the exchange record described herein, an individual, such as a court official or legal counsel in the case of a legal proceeding or a teacher in the case of an education environment, provided with access to the exchange record may, generally, gain access to the associated electronic document. As a result, the individual can easily gain access to the authentic version of the electronic document. There may be situations in which access to the electronic documents may be limited to certain individuals due to privacy and security concerns.

Also, in some embodiments, certain users may be associated with a user type and the user type may be associated with a predefined scope of access to the electronic documents. For example, a user identifier corresponding to a judge and/or his/her clerk can be associated with a judge user type. The described system can define the scope of access for the judge user type to include all electronic documents received in respect of the legal proceeding even if the judge/clerk were not specifically identified as recipients of those electronic documents. Other user types can include a prosecutor user type for a legal counsel working on behalf of the attorney general's office, a teacher user type for a teacher, teaching assistant and/or professor of a course, a student user type for a participant of a course, and other user types depending on the application of the described system.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

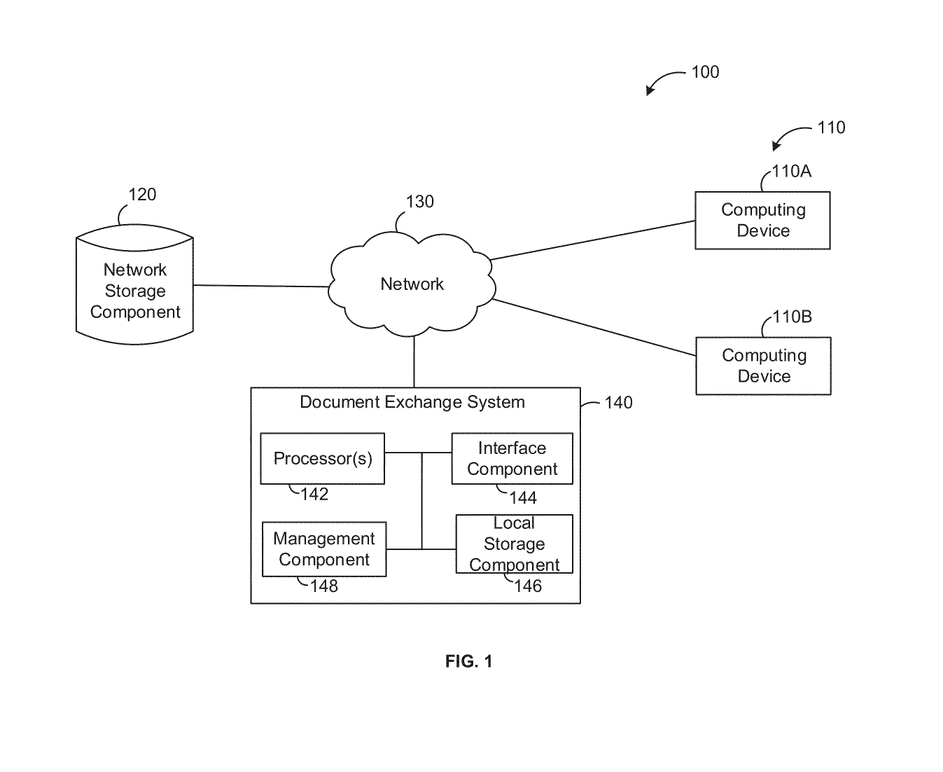

Reference is first made to FIG. 1, which illustrates a block diagram 100 of components interacting with a document exchange system 140. As shown, the document exchange system 140 is in electronic communication with a network storage component 120 and computing devices 110A and 110B via a network 130.

Each of the computing devices 110A, 110B may be any networked device operable to connect to the network 130. A networked device is a device capable of communicating with other devices through a network such as the network 130. A network device may couple to the network 130 through a wired or wireless connection.

As noted, these computing devices 110 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

In some embodiments, these computing devices 110 may be a laptop, or a smartphone device equipped with a network adapter for connecting to the Internet. In some embodiments, the connection request initiated from the computing devices 110A, 110B may be initiated from a web browser and directed at the browser-based communications application on the document exchange system 140.

In the illustrated example, each of the computing devices 110A and 110B may be associated with a different user. For example, the document exchange system 140 may receive the electronic document from a sender via the computing device 110A and the document exchange system 140 may provide one of the recipients with access to the electronic document. One of the recipients may then access the electronic document using the computing device 110B, for example. It will be understood that although two computing devices 110A, 110B are shown in FIG. 1, other number of computing devices 110 may access the document exchange system 140 via the network 130. For example, it may be possible for only one computing device 110 to be provided for receiving input from the various users and also displaying the relevant outputs to the respective users. It may also be possible for more than two computing devices 110 to access the document exchange system 140 via the network 130.

The network 130 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the computing devices 110, the document exchange system 140 and the network storage component 120.

The network storage component 120, as shown, is separate from the document exchange system 140. Generally, the network storage component 120 can be provided using any suitable data storage elements, such as disk drives, etc., and may include one or more databases (not shown) for storing information relating to, for example, the electronic documents and the users. In some embodiments, one database may be used to store this information. In some other embodiments, one database may be used to store, for example, information related to the electronic documents (e.g., a document database) and another database may be used to store, for example, information related to the users (e.g., a user information database). As will be described, the local storage component 146 within the document exchange system 140 may operate to provide similar functions as the network storage component 120.

The document exchange system 140 includes a processor 142, an interface component 144, a management component 148 and a local storage component 146. For ease of exposition, only one document exchange system 140 is shown. However, it will be understood that there may be multiple document exchange systems 140 distributed over a wide geographic area and connected via the network 130.

It will be understood that in some embodiments, each of the processor 142, the interface component 144, the management component 148 and the local storage component 146 may be combined into fewer number of components or may be separated into further components. Furthermore, the processor 142, the interface component 144, the management component 148 and the local storage component 146 may be implemented in software or hardware, or a combination of software and hardware.

The interface component 144 may be any interface that enables the document exchange system 140 to communicate with other devices and systems. In some embodiments, the interface component 144 can include at least one of a serial port, a parallel port or a USB port. The interface component 144 may also include at least one of an Internet, Local Area Network (LAN), Ethernet, Firewire, modem or digital subscriber line connection. Various combinations of these elements may be incorporated within the interface component 144.

For example, the interface component 144 may receive input from various input devices, such as a mouse, a keyboard, a touch screen, a thumbwheel, a track-pad, a track-ball, a card-reader, voice recognition software and the like depending on the requirements and implementation of the document exchange system 140.

The local storage component 146 can include RAM, ROM, one or more hard drives, one or more flash drives or some other suitable data storage elements such as disk drives, etc. The local storage component 146, like the network storage component 120, may include one or more databases (not shown) for storing information relating to, for example, the electronic documents and the users. In some embodiments, one database may be used to store this information. In some other embodiments, one database may be used to store, for example, information related to the electronic documents (e.g., a document database) and another database may be used to store, for example, information related to the users (e.g., a user information database).

Unlike the network storage component 120, the local storage component 146 can be provided as part of the document exchange system 140 and can be in electronic communication with the other components of the document exchange system 140, such as the processor 142, the interface component 144 and the management component 148, without accessing the network 130. It will be understood that, depending on the configuration of the document exchange system 140, the data stored at the local storage component 146 may be the same as or different from the data stored at the network storage component 120.

For example, in some embodiments, the local storage component 146 may operate as temporary storage for any data provided via the interface component 144. Since the local storage component 146 is accessible by the processor 142 without accessing the network 130, it may sometimes be more efficient to store data temporarily at the local storage component 146 and to transmit the data to the network storage component 120 when sufficient bandwidth becomes available at the network 130 and/or when access to the network 130 becomes available.

In some other embodiments, the data stored at each of the local storage component 146 and the network storage component 120 may be distinguished based on data types. For example, data that is more frequently accessed by the processor 142, such as some user information, may be stored at the local storage component 146, while data that is less frequently accessed by the processor 142, such as some electronic documents, may be stored at the network storage component 120. It will be understood that other configurations of the data storage may similarly be used depending on the requirements and implementation of the document exchange system 140.

The processor 142 may be any suitable processors, controllers or digital signal processors that can provide sufficient processing power depending on the configuration, purposes and requirements of the document exchange system 140. In some embodiments, the processor 142 can include more than one processor with each processor being configured to perform different dedicated tasks.

The processor 142 may be configured to control the operation of the document exchange system 140. The processor 142 can initiate and manage the operations of each of the other components in the document exchange system 140. The processor 142 may also determine, based on received data, stored data and/or user preferences, how the document exchange system 140 may generally operate.

For example, the processor 142 may be configured to receive an exchange initiation request from a user and to associate certain electronic documents with the exchange initiation request. The processor 142 may also be configured to initiate the management component 148, when appropriate.

The management component 148 can include various applications associated with facilitating the exchange of documents by the various users. In some embodiments, instructions associated with the methods described herein may be stored at the management component and implemented by the processor 142.

In some embodiments, the management component 148 may include a profile application for developing and maintaining a user profile for each user. The management component 148 may, in some embodiments, include a status application for providing a status of each of the electronic documents provided to the document exchange system 140. It will be understood that other applications may also be provided.

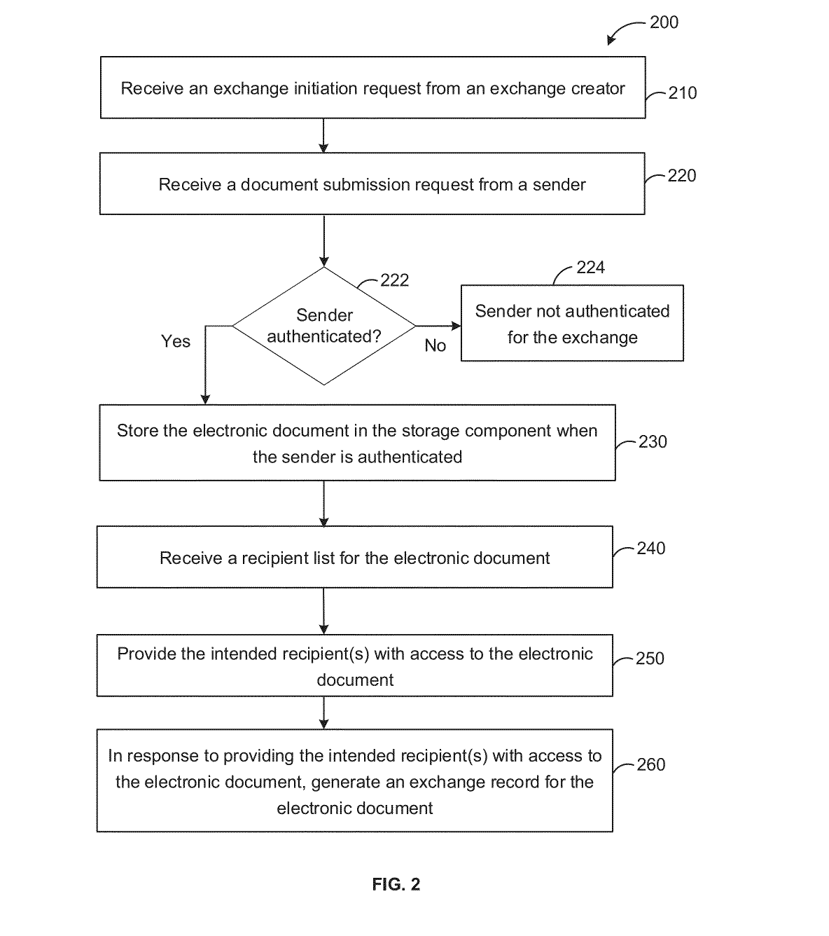

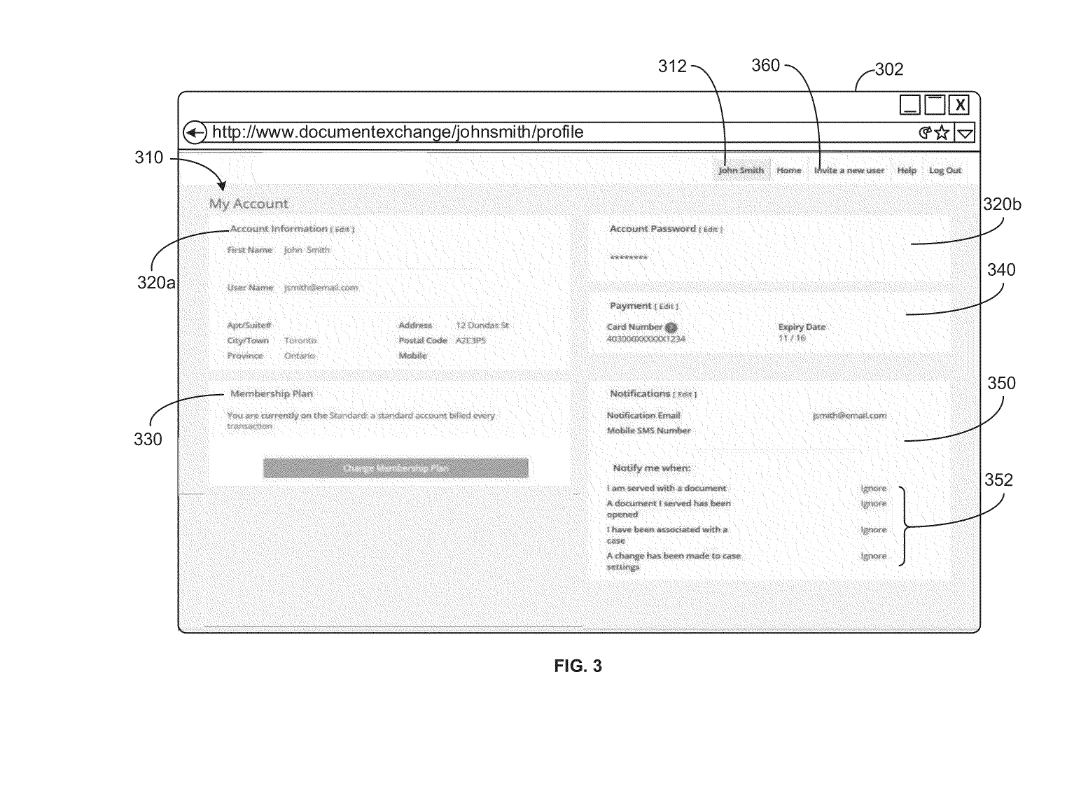

FIG. 2 is a flowchart diagram illustrating an example method 200 of exchanging electronic documents. To illustrate the method 200, reference will be made simultaneously to FIGS. 3 to 7 which illustrate various screenshots associated with an electronic document exchange system for legal proceedings. It will be understood that the method 200 may similarly be applied to different types of document exchange systems.

Legal proceedings can generally include any activity associated with a legal process, such as, but not limited to, a trial, arbitration, legal transactions (e.g., real estate, etc.), administrative hearings, etc. In the case of a trial, the legal proceeding can involve various participants, such as the defendant, the plaintiff and their respective counsels, presenting evidence and arguments before a decision maker or fact finder, such as a judge and/or jury. In the case of legal transactions, the legal proceeding can involve parties to the transaction (e.g., seller and purchaser, etc.) and their respective counsels defining and negotiating the terms of the legal transaction.

Generally, to access the document exchange system 140, individuals can register with the document exchange system 140 to have an account with the document exchange system and are referred to as users of the document exchange system 140.

FIG. 3 is a screenshot of an example user profile interface 310 for a user associated with the user identifier 312, John Smith. The user profile interface 310 may be accessed using a browser application 302 via a computing device, such as computing device 110A.

As shown in FIG. 3, as a user of the document exchange system 140, certain user preferences and account details can be stored for the user. In the example of FIG. 3, the user profile interface 310 for the user 312 includes account information 320, such as personal information 320a (e.g., name and address) and security credentials 320b (e.g., account password), membership information 330, payment information 340 (e.g., credit card information) and notification information 350 (e.g., preferred forms of notification, contact information, etc.).

The notification information 350 can also include notification preferences 352, such as when the user 312 will be notified and/or what can trigger a notification to be provided to the user 312. For example, the example notification preferences 352 of FIG. 3 allow for the user 312 to elect to be notified when served with an electronic document via the document exchange system 140, when a document served by the user 312 via the document exchange system 140 is accessed, when the user 312 is associated with a case (or legal proceeding) on the document exchange system 140, and/or when certain settings are changed. It will be understood that other example notification preferences 352 may similarly be provided.

It will also be understood that the types of information illustrated in the user profile interface 310 are merely examples and that other types of information may instead or also be provided.

As described, in some embodiments, certain users may be associated with a user type and the user type may be associated with a predefined scope of access to the electronic documents. For example, a judge user type can indicate that the corresponding user is to receive access to all electronic documents received in respect of the legal proceeding even if the judge/clerk were not specifically identified as recipients of those electronic documents. In another example, the sender can select a user type, such as the prosecutor user type, as recipient of the electronic document. It is possible that a prosecutor, arbitrator or judge may not be assigned to the legal proceeding when the electronic documents are being received by the system. Therefore, with the application of the user types, the document exchange system 140 can either notify a generic user account or the office of the respective user types of the electronic document (e.g., the office of the attorney general may be associated with an attorney general user account), and/or automatically provide access to the assigned prosecutor and/or judge when the document exchange system 140 receives a notification that a judge or prosecutor has been assigned to the document exchange.

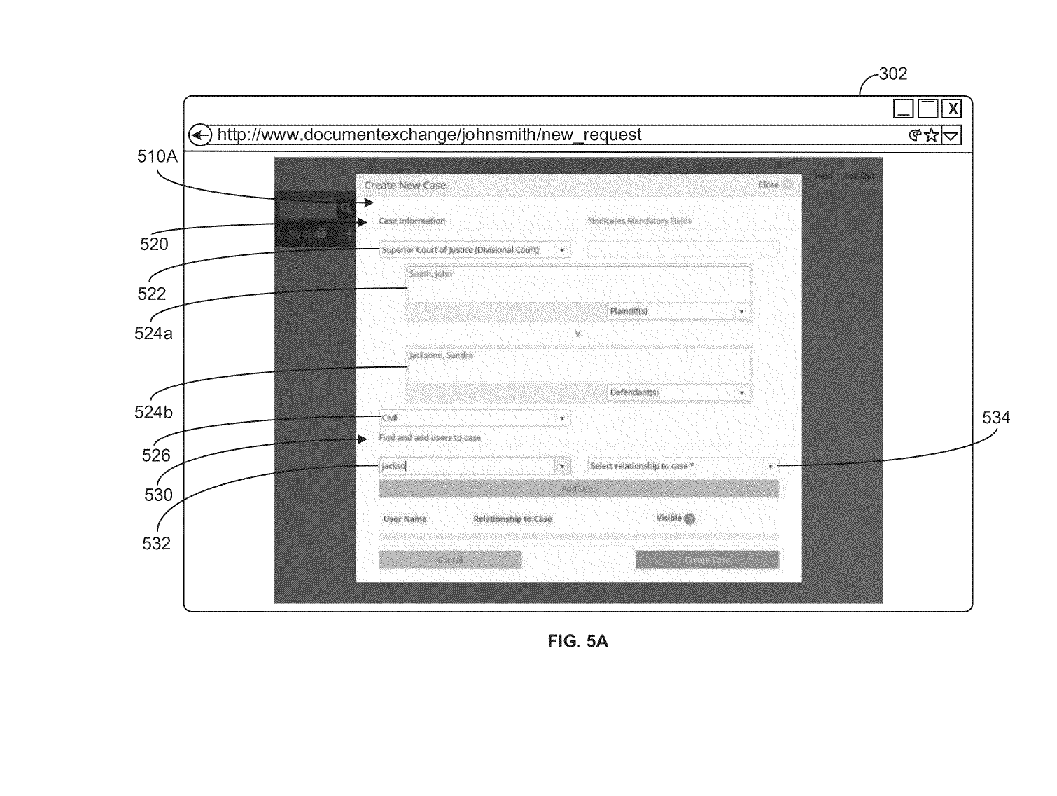

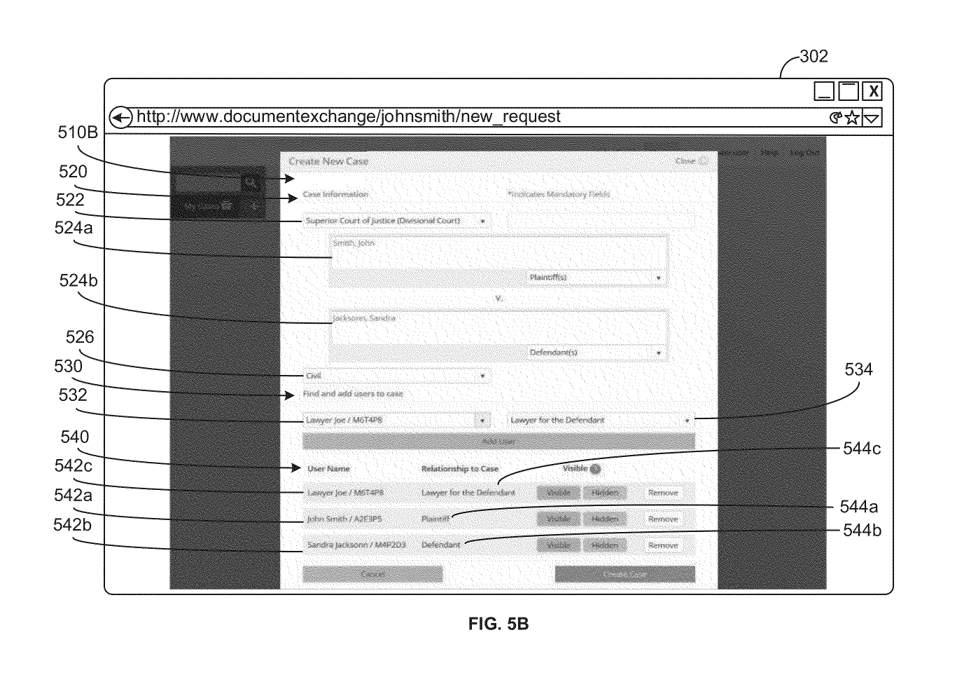

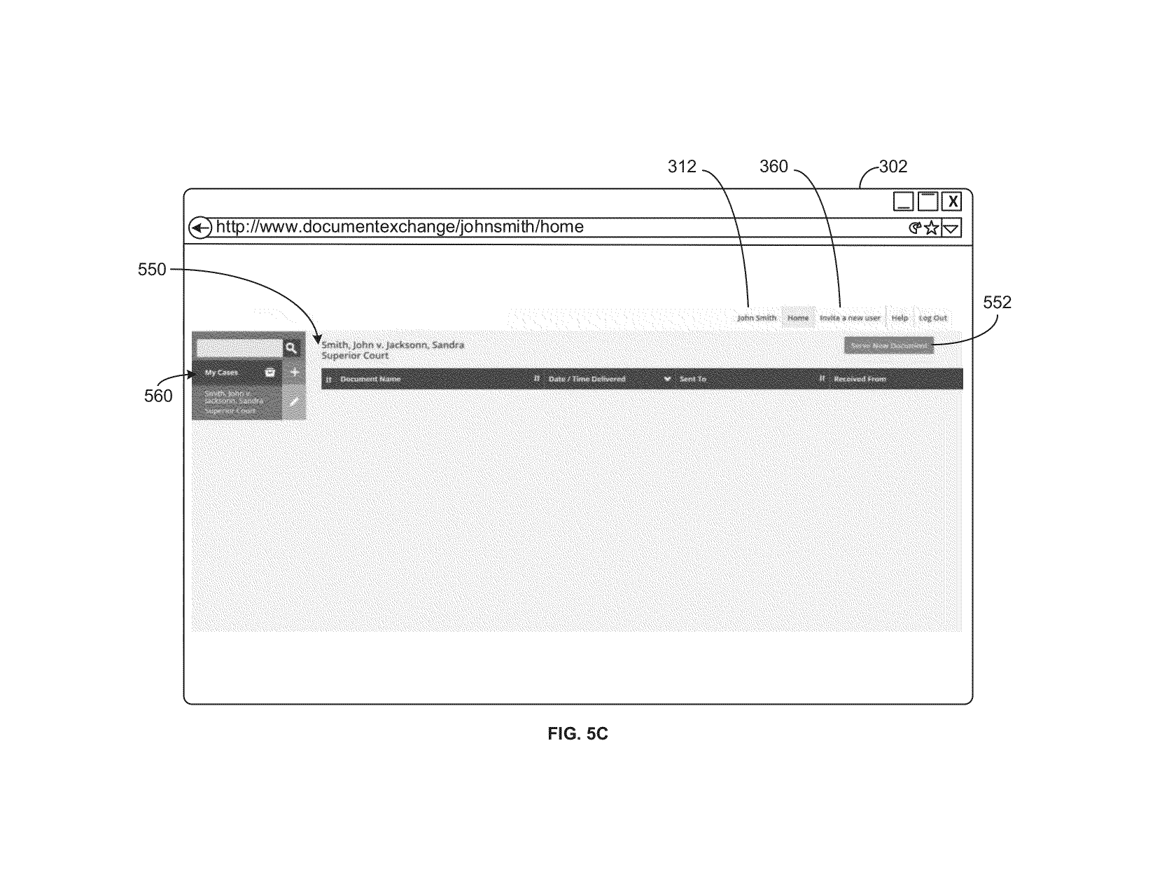

The examples to be described with reference to FIGS. 5 to 7 generally involve individuals who are users of the document exchange system 140.

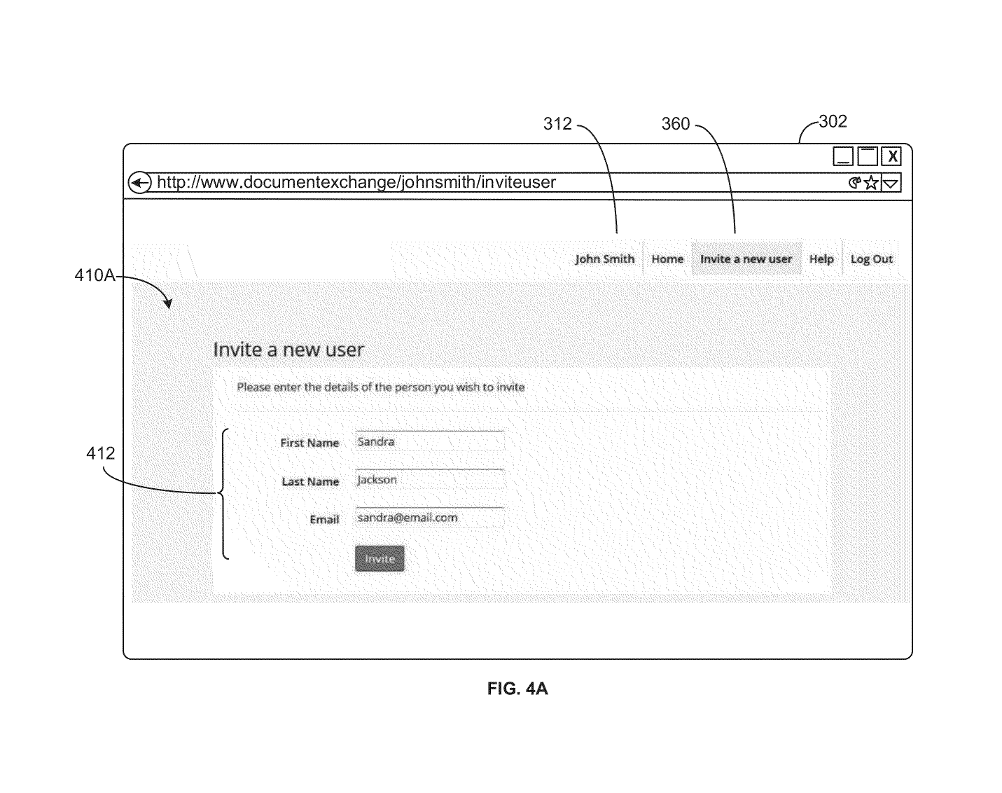

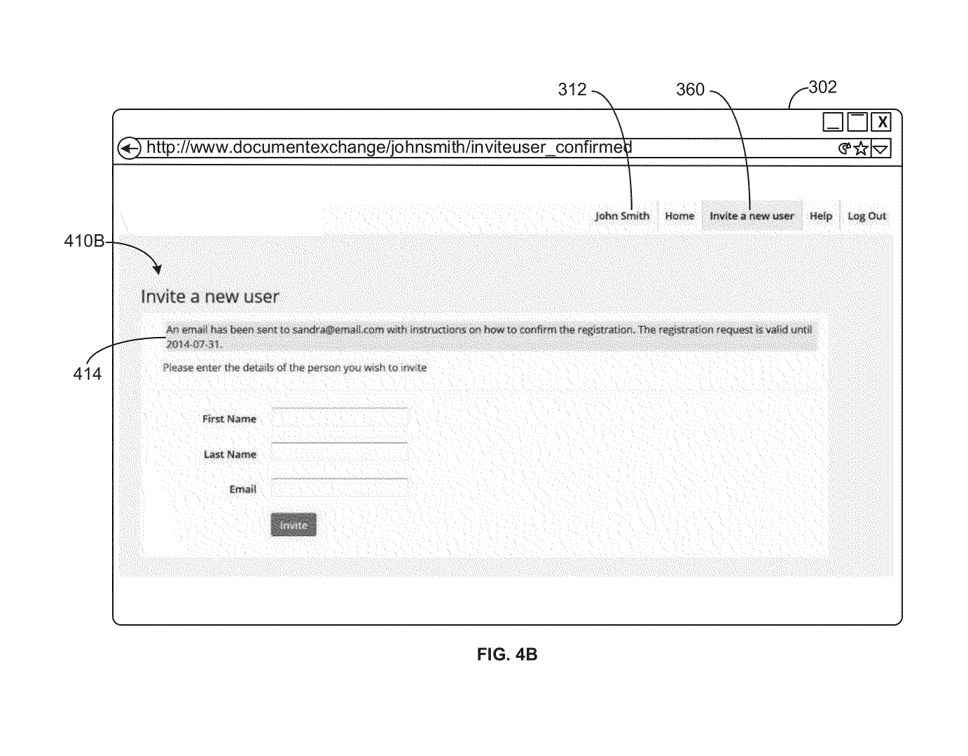

For example, the user 312 may send individuals invitations to become a user of the document exchange system 140 via a new user invitation interface. The new user invitation interface may be accessed via an invitation control 360 on the user profile interface 310. FIG. 4A illustrates a screenshot of an example new user invitation interface 410A in the browser application 302. As shown in FIG. 4A, the new user invitation interface 410A can include various fields 412 for identifying an invitee along with contact information for the invitee. It will be understood that other data fields, such as a message field, may also be provided in the new user invitation interface 410A. After the document exchange system 140 receives the invitation request via the new user invitation interface 410A, the document exchange system 140 can generate the new user invitation interface 410B including a confirmation message, such as the message 414 shown in FIG. 4B. It will be understood that other messages 414 may similarly be provided.

At 210, the processor 142 receives an exchange initiation request from an exchange creator.

The exchange initiation request can initiate a document exchange between certain users of the document exchange system 140. Generally, the exchange initiation request can include certain properties of the relevant legal proceedings to enable associated users to exchange electronic documents for that legal proceeding. An example exchange initiation request interface will now be described with reference to FIGS. 5A and 5B.

FIG. 5A illustrates an exchange initiation request interface 510A via the account interface of the user 312. The exchange initiation request interface 510A, in this example, includes case information fields 520 for receiving data associated with the legal proceeding and user selection fields 530 for receiving input selecting users associated with the legal proceeding.

The case information fields 520 can include a court selection dropdown box 522, one or more party identification fields 524 (such as a plaintiff field 524a and a defendant field 524b), and a proceeding type field 526. Other information, such as a court file number, may also be received via the case information fields 520. As shown in FIG. 5A, in this example, the plaintiff field 524a indicates that the user 312, John Smith, is the plaintiff in this example legal proceeding, while the defendant field 524b indicates that another individual, namely Sandra Jacksonn, is the defendant. The court selection dropdown box 522 indicates that the legal proceeding will take place before the Superior Court of Justice (Divisional Court) and the proceeding type field 526 indicates the legal proceeding is a civil matter.

The user selection fields 530 can include a user search control 532 for receiving inputs from the exchange creator identifying the relevant users to be associated with the legal proceeding. Each of the users selected may be associated with a user identifier. For embodiments in which one or more individuals are associated with the legal proceeding but are not users of the document exchange system 140, the user search control 532 will not be able to retrieve a user identifier for those individuals. In response, the document exchange system 140 can notify the exchange creator that the individuals are not users and provide the exchange creator with access to a new user invitation interface, such as 410A of FIG. 4A. The document exchange system 140 may temporarily include the individuals as part of the document exchange and associate the relevant user identifier to the exchange initiation request once the individual(s) becomes users.

The exchange initiation request can include a set of user identifiers to identify the users associated with the legal proceeding. The selected users are the users who should participate in the document exchange for that legal proceeding and/or be provided with access to electronic documents associated with the document exchange according to the exchange creator. The user identifier corresponding to the exchange creator may, in some embodiments, be automatically included in the set of identifiers.

The set of user identifiers can usually include two or more user identifiers. Also, the relationship, or user type, of the selected user can be provided to the document exchange system 140, such as via a relationship dropdown box 534 shown in FIG. 5A. The user identifiers can correspond to a party to the legal proceeding, such as a plaintiff or a defendant, or a legal counsel for one of the parties to the legal proceeding. An example set of user identifiers 540 is illustrated in FIG. 5B.

The set of user identifiers 540, as shown, includes a user identifier 542a corresponding to the plaintiff 544a (John Smith), a user identifier 542b corresponding to the defendant 544b (Sandra Jacksonn), and a user identifier 542c corresponding to a legal counsel for the defendant 544c (Lawyer Joe).

The exchange creator may be a user, such as administrator user, who is not associated with the legal proceeding. The exchange creator may, in some embodiments, access the document exchange system 140 to initiate the document exchange. For example, the document exchange system 140 may receive the exchange initiation request from a legal assistant of the defendant's legal counsel 54cc. The exchange creator in the example shown in FIGS. 5A and 5B is a user associated with the legal proceeding, namely, the plaintiff 544a.

In response to the exchange initiation request, the document exchange system 140 can then facilitate the document exchange by the identified users in respect of the legal proceeding. In some embodiments, the document exchange system 140 may create a user interface, such as an exchange summary interface 550 shown in FIG. 5C, for illustrating the document exchange. The relevant legal proceedings and cases may be identified generally at 560 of the exchange summary interface 550. Other user interfaces and controls may similarly be used for facilitating the document exchange.

At 220, the processor 142 receives a document submission request from a sender.

The sender can be any user associated with a user identifier. The user identifier associated with the sender may be referred to as the sender identifier.

When the document exchange system 140 receives the document submission request from the sender, the document exchange system 140 can authenticate the sender to ensure that the sender is authorized to engage in the document exchange at 222. That is, in the present example, the document exchange system 140 can determine whether the sender is a user authorized to engage in the document exchange for the legal proceeding. To determine whether the sender is an authorized user for the legal proceeding, the processor 142 can determine whether the sender identifier is within the set of user identifiers 540 provided at 210. The sender is authenticated for the legal proceeding when the sender identifier is determined, by the processor 142, to be within the set of user identifiers 540. When the sender is authenticated, the document exchange system 140 can also receive the electronic document from the sender.

However, when the processor 142 determines that the sender identifier is not within the set of user identifiers 540, the processor 142 can indicate that the sender is not authorized to engage in the document exchange accordingly (at 224).

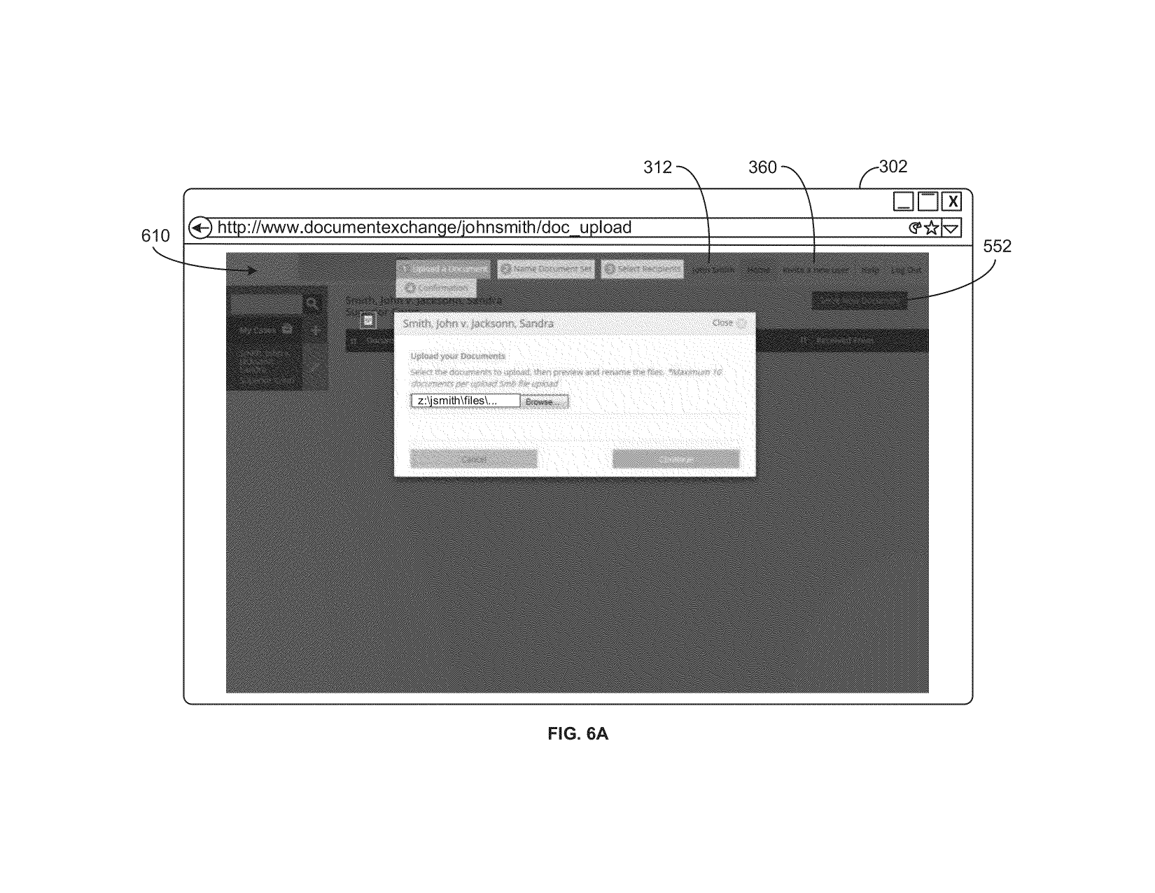

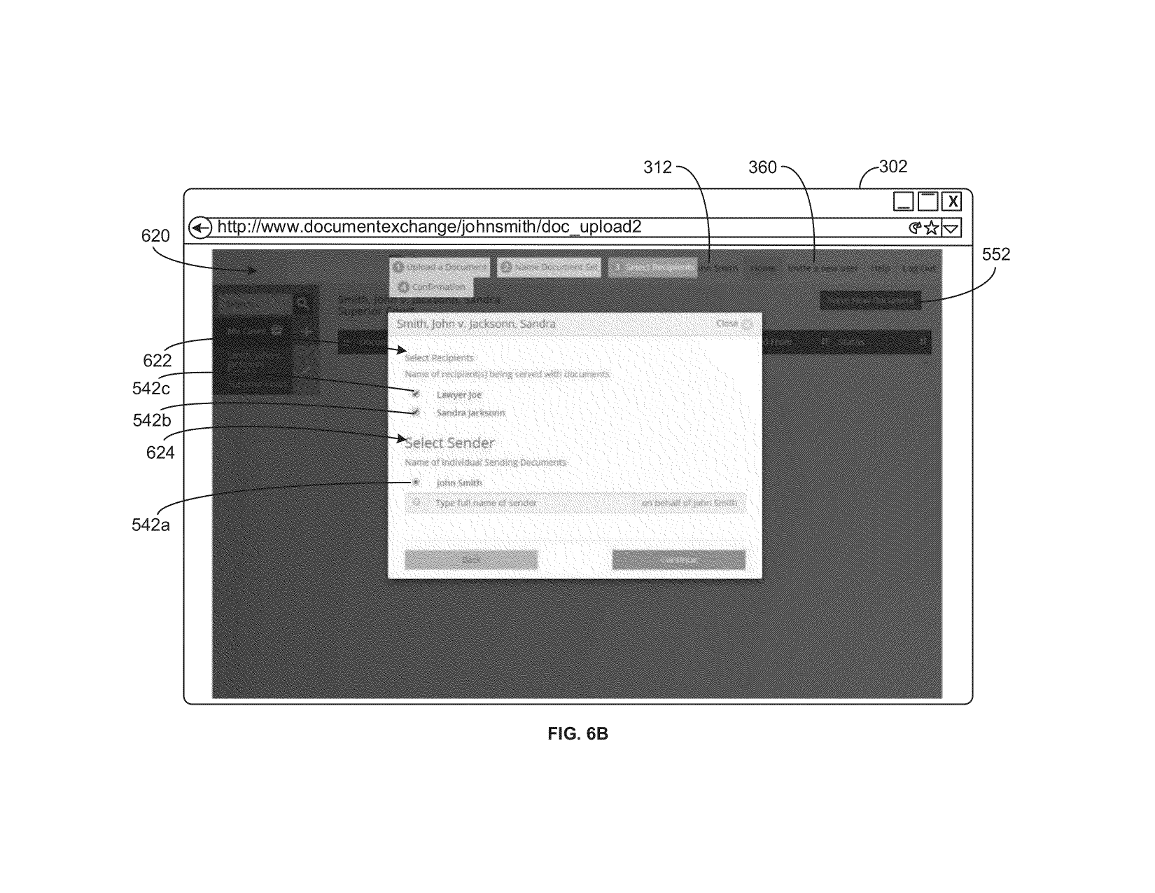

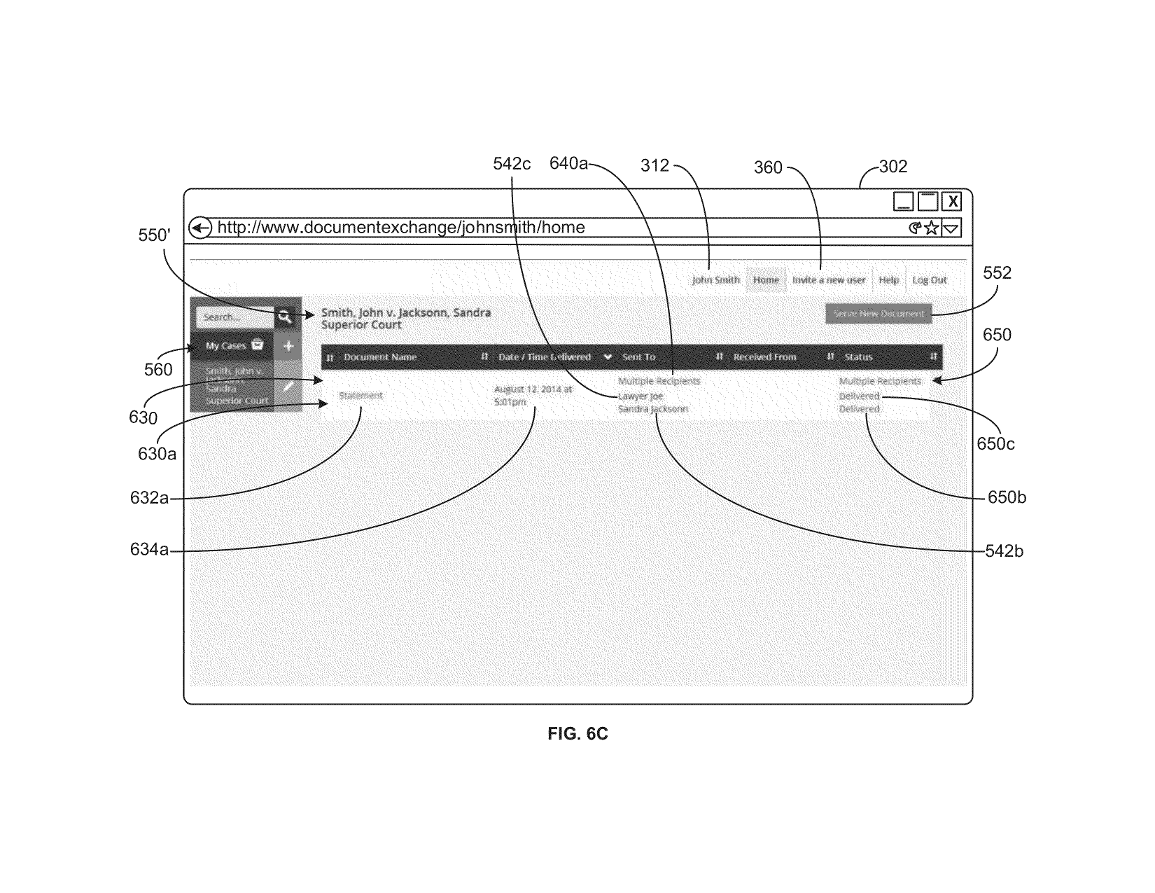

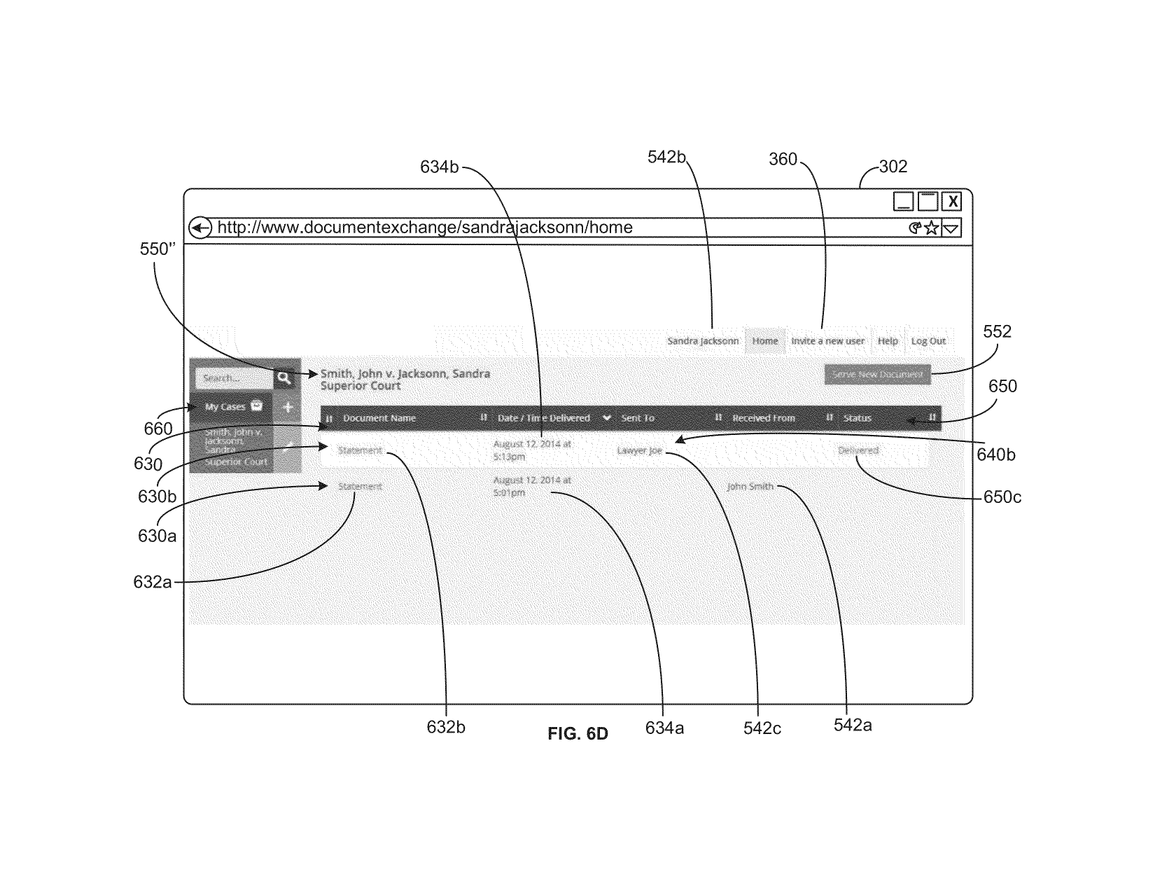

The document exchange system 140 can receive the electronic document from the sender via a document upload interface 610. The document upload interface 610 may be initiated via a document upload control 552 provided in the exchange summary interface 550 of FIG. 5C, for example. FIG. 6A illustrates a screenshot of an example document upload interface 610. The document upload interface 610 in this example includes a file browsing application. It will be understood that other types of file selection applications may similarly be used, such as a “drag-and-drop” application.

In some embodiments, the document exchange system 140 may also provide the sender with fields for providing further information associated with the electronic data, such as a name or type of the electronic document.

Also, FIG. 6A illustrates only one electronic document being provided to the document exchange system 140 but it will be understood that, depending on the configuration of the file selection and upload applications used, it may be possible to provide multiple electronic documents to the document exchange system 140 at any one time. In some embodiments, in response to receiving multiple electronic documents, the document exchange system 140 may combine the documents together to form a document set. The document exchange system 140 may also generate a summary or table of contents for the document set.

At 230, the processor 142 stores the electronic document in the storage component 120, 146 when the sender is authenticated at 222.

When the processor 142 determines that the sender identifier is within the set of user identifiers 540, the processor 142 can proceed to store the electronic document in the storage component 120, 146.

The storage component can be in electronic communication with the document exchange system 140. Therefore, the storage component may be the local storage component 146 and/or the network storage component 120. In some embodiments, the storage component can be separate from the document exchange system 140, such as the network storage component 120.

At 240, the processor 142 receives a recipient list for the electronic document.

Referring now to FIG. 6B, which is a screenshot of an example recipient selection interface 620.

The recipient selection interface 620 can include recipient selection fields 622.

The recipient selection fields 622 can include the set of user identifiers 540 provided in the exchange initiation request at 210. In the example of FIG. 6B, the recipient selection fields 622 includes a recipient selection field for each of the users, Lawyer Joe 542c (legal counsel for the defendant 544c) and Sandra Jacksonn 542b (defendant 544b). Both recipient selection fields are selected in the example of FIG. 6B—that is, the sender intends for both Lawyer Joe 542c and Sandra Jacksonn 542b to receive the electronic document. However, it will be understood that the sender may not provide the electronic document to all users identified as being associated with the legal proceeding. For example, the sender may decide to only provide the electronic document to the legal counsels, such as Lawyer Joe 542c.

The recipient list can include the recipient identifiers corresponding to the selected recipient selection fields 622.

In the example of FIG. 6B, sender selection fields 624 are also provided. In some embodiments, the sender may be providing the electronic document on behalf of another user and so, the sender may indicate that the electronic document is being provided on behalf of another user within the set of user identifiers 540. For example, the document exchange system 140 may receive the electronic document from a law clerk assisting a legal counsel associated with the legal proceeding. The document exchange system 140 can indicate that the law clerk is providing the electronic document on behalf of the legal counsel.

At 250, the processor 142 provides the intended recipient or recipients with access to the electronic document.

The document exchange system 140 can provide the intended recipient(s) access to the electronic document directly, or indirectly via a listing of electronic documents for which the recipient has been provided access. The listing of electronic documents can be specific to a certain document exchange (such as the listing shown in FIG. 6C) or can include documents for which that recipient has be provided access regardless of the document exchange. For example, when a recipient user logs into the document exchange system 140, the document exchange system 140 can generate a listing of all available documents that have not be accessed by that recipient user. The listing of all available documents may be limited by certain time periods as determined by the document exchange system 140 and/or the recipient user. For example, the listing of all available documents may include only documents that have not be accessed by the recipient user and received by the document exchange system 140 within the past three months.

FIG. 6C is a screenshot of an updated version of the exchange summary interface 550 of FIG. 5C, namely an updated exchange summary interface 550′, after the electronic document is received by the document exchange system 140. The exchange summary interface 550 can include a listing of electronic documents 630 for each legal proceeding or case identified generally at 560.

As shown in FIG. 6C, the listed electronic document 630a corresponds to the electronic document provided via the document upload interface 610 of FIG. 6A as described with reference to 220. The electronic document 630 is associated with a title 632a (“Statement”) and a delivery timestamp 634a (Aug. 12, 2014 at 5:01 pm). As described with reference to FIG. 6B, the recipient list 640a for the electronic document 630a includes all other users associated with the legal proceeding, namely Lawyer Joe 542c and Sandra Jacksonn 542b. As described, the recipient list 640 for an electronic document 630 can vary and may not necessarily include all users associated with the document exchange.

A status 650 can also be provided for each delivery of the electronic document 630a. For example, the status 650b and 650c indicates that the electronic document 630a has been delivered to each of the intended recipients. According to the statuses 650b and 650c shown in FIG. 6C, the document exchange system 140 has provided the recipients in the recipient list with access to the electronic document 630a.

FIG. 6D is a screenshot of another exchange summary interface 550″. The exchange summary interface 550″ is provided via an account associated with the defendant 544b (Sandra Jacksonn). As shown in FIG. 6D, the electronic document 630a can be accessed by the defendant 544b via the exchange summary interface 550″. Also, the exchange summary interface 550″ indicates that the defendant 544b has provided another electronic document 630b to the document exchange system 140 with a recipient list 640b including only her legal counsel, Lawyer Joe 542c. The electronic document 630b is also associated with a title 632b, a timestamp 634b and a delivery status 650c.

In some embodiments, the document exchange system 140 may, in response to receiving the electronic document 630, generate a notification of receipt. The notification may then be provided to the users in the respective recipient list 640 and/or the sender in various forms, such as an electronic mail or text message. The notification may include some information associated with the legal proceeding, the electronic document and/or the sender. The notification may also include the status 650 of the electronic document 630. For example, the status 650 may be any one of delivered, opened and/or saved. Other example statuses may similarly be used to describe the electronic documents 630.

The exchange record may, in some embodiments, be sent together with the notification of receipt of the electronic document 630 by the document exchange system 140.

In some embodiments, the document exchange system 140 can also track the actions conducted by the recipients in respect of the electronic document. For example, the document exchange system 140 can maintain a record of which recipient has accessed the electronic document and, in some embodiments, the type of access, such as whether a copy of the electronic document was downloaded from the document exchange system 140 to the computing device 1108, and/or opened via the document exchange system 140. The document exchange system 140 may also track a length of time and/or frequency in which the electronic document may have been accessed.

At 260, in response to providing the intended recipient(s) 640 with access to the electronic document 630, the processor 142 generates an exchange record for the electronic document 630.

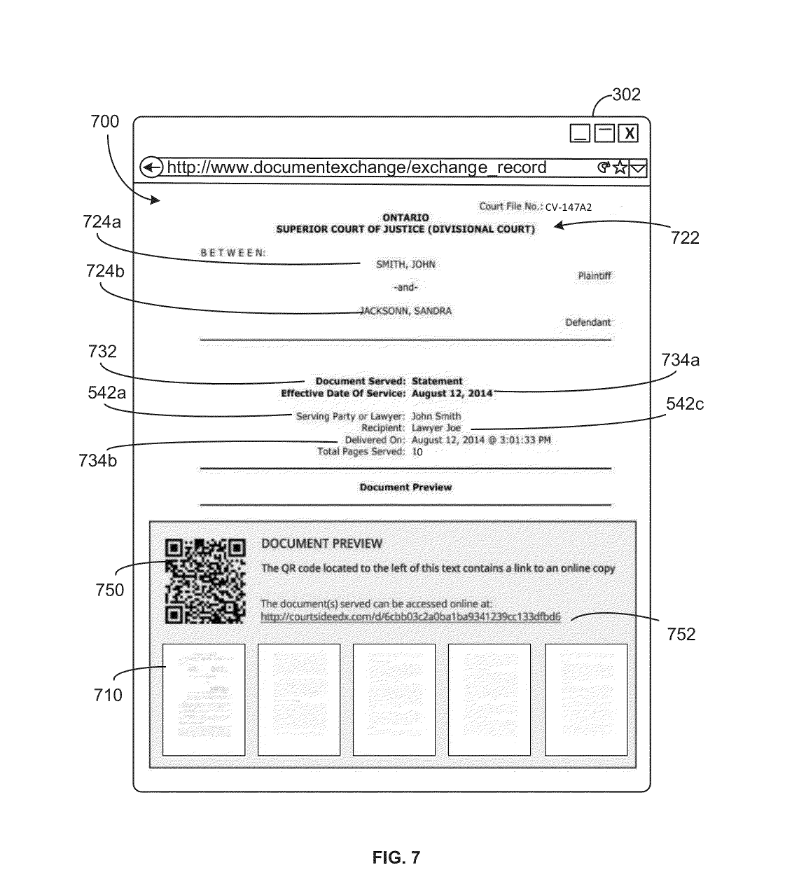

The exchange record generally indicates that the electronic document 630 was received by the document exchange system 140. Various different information can be included in the exchange record. In particular, as will be described with reference to FIG. 7, the exchange record can include a receipt confirmation and an access link to the electronic document 630 stored in the storage component 120, 146.

FIG. 7 is a screenshot of an example exchange record 700 for the delivery of the electronic document 630a to Lawyer Joe 542c by the plaintiff 544a.

The exchange record 700, in this example, includes various information regarding the legal proceeding (e.g., jurisdiction 722, parties to the legal proceeding 724 and the relationship or user types of those parties), the electronic document 630a itself (e.g., title 732, a screenshot 710 of a page from the electronic document 630a, a total number of pages, sender of the electronic document 630a, recipient(s) of the electronic document 630a), and/or the document receipt and delivery (e.g., timestamp 734a indicating when the electronic document 630a was received by the document exchange system 140, timestamp 734b indicating when the electronic document 630a was delivered to the recipient, Lawyer Joe 542c).

One or more users in the recipient list 640 of the electronic document 630a may also be identified in the corresponding exchange record 700. As shown in FIG. 7, the exchange record 700 indicates that the recipient is Lawyer Joe 542c. Although, in this example, a unique exchange record 700 is generated by the document exchange system 140 for each recipient 640 of the electronic document 630a, it is possible for fewer exchange records 700 to be generated. For example, one exchange record 700 can be generated for the electronic document 630a and include the recipient list 640.

The exchange record 700 also includes a receipt verification link 750 to the exchange record 700 stored in the storage component 120, 146. The receipt verification link 750 can ensure that the authentic exchange record 700 is being accessed. The exchange record 700 may also include an access link 752 to the electronic document 630a as it is stored in the storage component 120, 146.

The receipt verification link 750 and the access link 752 may be provided in different forms. For example, as shown in FIG. 7, the access link 752 may be provided as a Universal Resource Link (URL) and the receipt verification link 750 may be provided as a URL that is encoded as a Quick Response (QR) code Although both the access link 752 and the receipt verification link 750 are shown in FIG. 7, it will be understood that one or the other may be provided. It will also be understood that alternative representations of the access link 752 and the receipt verification link 750 may similarly be provided in the exchange record 700.

As described, certain settings, especially in legal proceedings and education environments, involve strict timelines for all parties. The timelines are important in maintaining procedural fairness and, at the same time, minimizing unnecessary delays in the legal proceeding. It can, therefore, be critical to ensure the timelines are met. With the described methods and systems, an individual, such as a court official, presented with the exchange record 700 can authenticate the exchange record 700 itself via the receipt verification link 750 and the timing of the electronic document submission using the receipt confirmation information. As well, the individual can authenticate the version of the electronic document 630a with the access link 752. The access link 752 enables direct access to the version of the electronic document 630a associated with the exchange record 700. As a result, undesired and unwarranted alterations to the exchange record 700 and the electronic document 630a can be prevented.

The document exchange system 140 may then provide the sender with access to the exchange record 700. For the example shown in FIG. 7, the intended recipient is Lawyer Joe 542c.

Various embodiments have been described herein by way of example only. Various modification and variations may be made to these example embodiments without departing from the spirit and scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

We claim:

1. A method of exchanging electronic documents for a legal proceeding, the method comprising:
receiving, by a document exchange system, an exchange initiation request from an exchange creator, the exchange initiation request comprising a set of user identifiers and the set of user identifiers including two or more user identifiers corresponding to respective users associated with the legal proceeding;
receiving, by the document exchange system, a document submission request from a sender for the legal proceeding, the sender being associated with a sender identifier, wherein receiving the document submission request comprises determining whether the sender identifier is within the set of user identifiers to authenticate the sender is a user associated with the legal proceeding and receiving an electronic document from the sender;
storing the electronic document in a storage component when the sender is authenticated and otherwise, indicate the sender is not associated with the legal proceeding, the storage component being in electronic communication with the document exchange system;
receiving, from the sender, a recipient list for the electronic document, the recipient list comprising one or more recipient identifiers associated with one or more respective intended recipients of the electronic document and the one or more recipient identifiers being within the set of user identifiers;
providing the one or more intended recipients with access to the electronic document; and
in response to providing the one or more intended recipients with access to the electronic document, generating, by the document exchange system, an exchange record for the electronic document, the exchange record providing, at least, (i) a receipt confirmation indicating the electronic document was received by the document exchange system and (ii) a receipt verification link to the exchange record stored in the storage component.

2. The method of claim 1, wherein the exchange record further includes an access link to the electronic document stored in the storage component.

3. The method of claim 1, wherein the storage component is separate from the document exchange system.

4. The method of claim 1, wherein the receipt verification link comprises a Universal Resource Link (URL) and the URL provides access to the exchange record stored in the storage component.

5. The method of claim 4, wherein the URL is encoded as a Quick Response (QR) code.

6. The method of claim 2, wherein the access link comprises a Universal Resource Link (URL) and the URL provides access to the electronic document stored in the storage component.

7. The method of claim 1, wherein generating the exchange record for the electronic document comprises:
generating a unique exchange record for each recipient identifier in the recipient list, each unique exchange record including, at least, a recipient name associated with the respective recipient identifier.

8. The method of claim 1, wherein generating the exchange record for the electronic document comprises providing the sender with access to the exchange record.

9. The method of claim 1, wherein providing the one or more intended recipients with access to the electronic document via the document exchange system comprises:
generating a notification of the receipt of the electronic document by the document exchange system; and
transmitting the notification to the one or more intended recipients.

10. The method of claim 1, wherein the exchange record further comprises data associated with at least one of (i) the electronic document and (ii) the legal proceeding.

11. The method of claim 10, wherein the data associated with the electronic document comprises a screenshot of at least one page of the electronic document.

12. The method of claim 1, wherein the receipt confirmation comprises at least a timestamp and a recipient name corresponding to at least one recipient identifier in the recipient list.

13. The method of claim 1, wherein the two or more user identifiers comprise a user identifier corresponding to at least one of (i) a party to the legal proceeding and (ii) a legal counsel for one of the parties to the legal proceeding.

14. The method of claim 1, wherein the exchange creator is an administrator user who is not associated with a user identifier within the set of user identifiers.

15. A system of exchanging electronic documents for a legal proceeding, the system comprising:
a storage component; and
at least one processor in electronic communication with the storage component, the at least one processor being configured to:
receive an exchange initiation request from an exchange creator, the exchange initiation request comprising a set of user identifiers and the set of user identifiers including two or more user identifiers corresponding to respective users associated with the legal proceeding;
receive a document submission request from a sender for the legal proceeding, the sender being associated with a sender identifier, wherein receiving the document submission request comprises determining whether the sender identifier is within the set of user identifiers to authenticate the sender is a user associated with the legal proceeding and receiving an electronic document from the sender;
storing the electronic document in the storage component when the sender is authenticated and otherwise, indicate the sender is not associated with the legal proceeding;
receive, from the sender, a recipient list for the electronic document, the recipient list comprising one or more recipient identifiers associated with one or more respective intended recipients of the electronic document and the one or more recipient identifiers being within the set of user identifiers;
provide the one or more intended recipients with access to the electronic document; and
in response to providing the one or more intended recipients with access to the electronic document, generate an exchange record for the electronic document, the exchange record providing, at least, (i) a receipt confirmation indicating the electronic document was received and (ii) a receipt verification link to the exchange record stored in the storage component.

16. The method of claim 15, wherein the exchange record further includes an access link to the electronic document stored in the storage component.

17. The system of claim 15, wherein the storage component is separate from the at least one processor.

18. The system of claim 15, wherein the receipt verification link comprises a Universal Resource Link (URL) and the URL provides access to the exchange record stored in the storage component.

19. The system of claim 18, wherein the URL is encoded as a Quick Response (QR) code.

20. The system of claim 16, wherein the access link comprises a Universal Resource Link (URL) and the URL provides access to the electronic document stored in the storage component.

21. The system of claim 15, wherein the at least one processor is further configured to:
generate a unique exchange record for each recipient identifier in the recipient list, each unique exchange record including, at least, a recipient name associated with the respective recipient identifier.

22. The system of claim 15, the at least one processor is further configured to provide the sender with access to the exchange record.

23. The system of claim 15, wherein the at least one processor is further configured to:
generate a notification of the receipt of the electronic document; and
transmit the notification to the one or more intended recipients.

24. The system of claim 15, wherein the exchange record further comprises data associated with at least one of (i) the electronic document and (ii) the legal proceeding.

25. The system of claim 24, wherein the data associated with the electronic document comprises a screenshot of at least one page of the electronic document.

26. The system of claim 15, wherein the receipt confirmation comprises at least a timestamp and a recipient name corresponding to at least one recipient identifier in the recipient list.

27. The system of claim 15, wherein the two or more user identifiers comprise a user identifier corresponding to at least one of (i) a party to the legal proceeding and (ii) a legal counsel for one of the parties to the legal proceeding.

28. The system of claim 15, wherein the exchange creator is an administrator user who is not associated with a user identifier within the set of user identifiers.
